(19) United States
(12) Patent Application Publication
(10) Pub. No.: US 2017/0073191 A1
(43) Pub. Date: Mar. 16, 2017

(54) ELECTRICALLY ACTUABLE SAFETY DEVICE FOR A LIFT INSTALLATION AND METHOD FOR TRIGGERING SUCH A DEVICE

(71) Applicants: THYSSENKRUPP ELEVATOR AG, Essen (DE); THYSSENKRUPP AG, Essen (DE)

(72) Inventors: Gerhard THUMM, Filderstadt (DE); Gerhard Schiffner, Ostfildern (DE); Holger Zerelles, Leinfelden-Echterdingen (DE); Walter Hoffman, Niedernhausen (DE)

(21) Appl. No.: 15/262,525

(22) Filed: Sep. 12, 2016

(30) Foreign Application Priority Data
Sep. 11, 2015 (DE) 102015217423.9

(51) Int. Cl. B66B 5/18; B66B 5/00; B66B 1/32; B66B 5/22

(52) U.S. Cl. CPC B66B 5/18; B66B 5/22; B66B 5/0031; B66B 1/32

(57) ABSTRACT

The invention relates to a safety device for a lift installation, having an intercepting mechanism, which, when actuated, is designed to brake a movement of a lift car of the lift installation, an actuating mechanism, which is configured to assume a first and a second position, the actuating mechanism leaving the intercepting mechanism non-actuated in the first position and actuating the intercepting mechanism in the second position, having a pressure accumulator, which forces the actuating mechanism into the second position, a holding device, which holds the actuating mechanism in the first position by using a permanent magnet, and an electromagnet, which is configured to release the holding device when energized, in order to cause the pressure accumulator to force the actuating mechanism into the second position.

### CROSS REFERENCE TO RELATED APPLICATIONS

This application claims priority to German Application No. 102015217423.9 filed on Sep. 11, 2015. The disclosure of the above application is incorporated herein by reference in its entirety.

### FIELD

The present invention relates to a safety device for a lift installation according to the pre-characterizing clause of Patent claim 1, and to a method for triggering a safety device.

### BACKGROUND

WO 2012/080102 A1 describes an apparatus and method for actuating and restoring a safety device of a lift installation, which safety device has at least one intercepting element for clamping a braking surface or a guide rail. The apparatus includes a pressure accumulator, preferably a compression spring, and an actuator driven by the pressure accumulator which, if required, can move at least two intercepting elements of the safety device substantially synchronously into an intercepting position, and a remotely actuable restoring device, which can bias the actuator or pressure accumulator into a standby position again. A holding device has a holding latch held by means of an electromagnet and triggered by means of spring force, which holding latch is configured to hold the actuator in the standby position.

According to the invention, a safety device for a lift installation and a method for triggering a safety device having the features of the independent patent claims are proposed. Advantageous refinements are the subject-matter of the dependent claims and of the following description.

As opposed to the prior art, the invention proposes to release a holding device electromagnetically which holds an actuating mechanism in a first position by using a permanent magnet, in which an intercepting mechanism of the safety device is not actuated, in order as a result to cause the pressure accumulator to force the actuating mechanism into a second position, in which the intercepting mechanism is actuated. As opposed to the prior art, where an electromagnet must be energized continuously, with the associated disadvantages in particular with regard to energy consumption and waste heat, the electromagnet is not energized during normal operation in the present invention, so that energy for the electromagnetic and for otherwise necessary cooling devices is saved.

Preferably, the safety device also has a restoring mechanism, which is configured to restore the actuating mechanism from the second position into the first position and/or to restore the intercepting mechanism from the actuated position into the non-actuated position. The restoring mechanism preferably operates by means of an electric motor, so that simple re-starting of a triggered safety device is possible. In order to be able to apply high restoring forces, the restoring mechanism can have a spindle drive.

On the other hand, in order not to have to effect triggering of the intercepting mechanism counter to forces from the restoring mechanism, the restoring mechanism preferably has a freewheeling mechanism, for example a movable pin in a slot, which permits a movement of the intercepting mechanism from the non-actuated position into the actuated position without moving the restoring mechanism.

In order to improve the operational reliability, a restoring mechanism monitoring means is preferably provided, which monitors whether a movement of the intercepting mechanism from the non-actuated position into the actuated position without moving the restoring mechanism is permitted. For this purpose, the restoring mechanism monitoring means can in particular monitor or check whether the freewheeling functionality is provided.

In order to further improve the operational reliability, an intercepting mechanism monitoring means is preferably provided, which monitors whether the intercepting mechanism is in the actuated or the non-actuated position. This information is, for example, relevant to the control of a lift car drive, in order to avoid overloading here or to permit or prevent operation at all.

The aforementioned monitoring means can, for example, have a sensor, a contact switch, a light barrier or the like.

In a preferred refinement, the actuating mechanism is coupled directly to the intercepting mechanism, so that the intercepting mechanism is non-actuated when the actuating mechanism assumes the first position. In this case, with a restoration with a safety device triggered, both actuating mechanism and intercepting mechanism are restored, which makes the operation particularly simple (in particular when the restoring mechanism just described is used).

In a likewise preferred refinement, the actuating mechanism is coupled to the intercepting mechanism by means of a freewheeling mechanism, which freewheeling mechanism permits the actuating mechanism to be restored from the second position into the first position without simultaneously restoring the intercepting mechanism from the actuated position into the non-actuated position. For example, it is possible to stipulate that an actuated intercepting mechanism may be reset only manually, which is possible in this embodiment, even if there is a restoring mechanism (possibly electric-motor driven) for the actuating mechanism.

The intercepting mechanism preferably has a self-reinforcing brake, such as a wedge brake or eccentric brake. In the case of a wedge brake, a wedge-like braking element is, for example, introduced between a holder on the lift-car side and a guide rail. In the case of an eccentric brake, a curved braking element (e.g. round, elliptical, spiral or the like), which is rotatably mounted eccentrically, for example on a holder on the lift-car side, is set or pivoted against the guide rail. In both cases, by means of an appropriate configuration, advantageous self-reinforcement can be achieved, so that only small forces have to be applied by the actuating mechanism, so that the latter can be formed very easily and with very little complexity.

The actuating mechanism preferably has a lever mechanism or a coupler mechanism. Therefore, actuating and restoring forces can be magnified as desired. Furthermore, the safety device can be designed to be compact and small.

In order to further improve the operational reliability, there is preferably an energy storage device for energizing the electromagnet in the event of failure of an external power supply.

Expediently, the pressure accumulator has a spring, in particular a tension spring or compression spring, or a pneumatic or hydraulic pressure accumulator. Therefore, higher forces can be generated with little space required. A pneumatic or hydraulic pressure accumulator can, moreover, also be placed relatively arbitrarily, since the pressurized fluid can be led to the desired point via lines.

Further advantages and refinement of the invention emerge from the description and the appended drawing.

It goes without saying that the features mentioned above and those still be explained below can be used not only in the respectively specified combination but also in other combinations or on their own without departing from the scope of the present invention.

The invention is illustrated schematically in the drawing by using an exemplary embodiment and will be described below with reference to the drawing.

### SUMMARY

A safety device for a lift installation according to the present disclosure includes an intercepting mechanism, an actuating mechanism, a pressure accumulator, a holding device and an electromagnet. The intercepting mechanism, when actuated, is designed to brake a movement of a lift car of the lift installation. The actuating mechanism, is configured to assume a first and a second position. The actuating mechanism leaves the intercepting mechanism non-actuated in the first position and actuating the intercepting mechanism in the second position. The pressure accumulator forces the actuating mechanism into the second position. The holding device holds the actuating mechanism in the first position by using a permanent magnet. The electromagnet is configured to release the holding device when energized in order to cause the pressure accumulator to force the actuating mechanism into the second position.

According to other features, the safety device further comprises a restoring mechanism. The restoring mechanism is configured to at least one of (i) restore the actuating mechanism from the second position to the first position and (ii) restore the intercepting mechanism from the actuated position into the non-actuated position. The restoring mechanism has at least one of an electric motor and a spindle drive. The restoring mechanism has a freewheeling mechanism which permits a movement of the intercepting mechanism from the non-actuated position into the actuated position without moving the restoring mechanism. The safety device has a restoring mechanism monitoring means which monitors whether a movement of the intercepting mechanism from the non-actuated position into the actuated position without moving the restoring mechanism is permitted.

The safety device further includes an intercepting mechanism monitoring means which monitors whether the intercepting mechanism is in the actuated or non-actuated position. The actuating mechanism is coupled directly to the intercepting mechanism so that the intercepting mechanism is non-actuated when the actuating mechanism assumes the first position. The actuating mechanism is coupled to the intercepting mechanism by means of a freewheeling mechanism. The freewheeling mechanism permits the actuating mechanism to be restored from the second position into the first position without simultaneously restoring the intercepting mechanism from the actuated position into the non-actuated position.

According to other features, the intercepting mechanism has a self-reinforcing brake. The actuating mechanism has one of a lever mechanism and a coupler mechanism. The safety device further comprises an energy storage device for energizing the electromagnet in the event of a failure of an external power supply. The pressure accumulator comprises one of a spring, a pneumatic pressure accumulator and a hydraulic pressure accumulator.

A method for triggering a safety device for a lift installation is provided. An electromagnet is energized in order to weaken a magnetic field from a permanent magnet to such an extent that an intercepting mechanism of the safety device, which is kept non-actuated by means of the permanent magnet and which is designed to brake a movement of a lift car of the lift installation when actuated is actuated. The intercepting mechanism is actuated by a pressure accumulator that is under pressure. In order to restore the intercepting mechanism, the pressure accumulator is pressurized and is then kept pressurized by the permanent magnet.

### BRIEF DESCRIPTION OF THE DRAWINGS

FIG. 1 shows, schematically, a preferred embodiment of a safety device according to the invention for a lift installation in the non-triggered state; and

FIG. 2 shows the safety device from FIG. 1 in the triggered state.

### DETAILED DESCRIPTION

In the various figures, the same parts are always provided with the same reference, and are therefore in each case also generally only referred to or mentioned once.

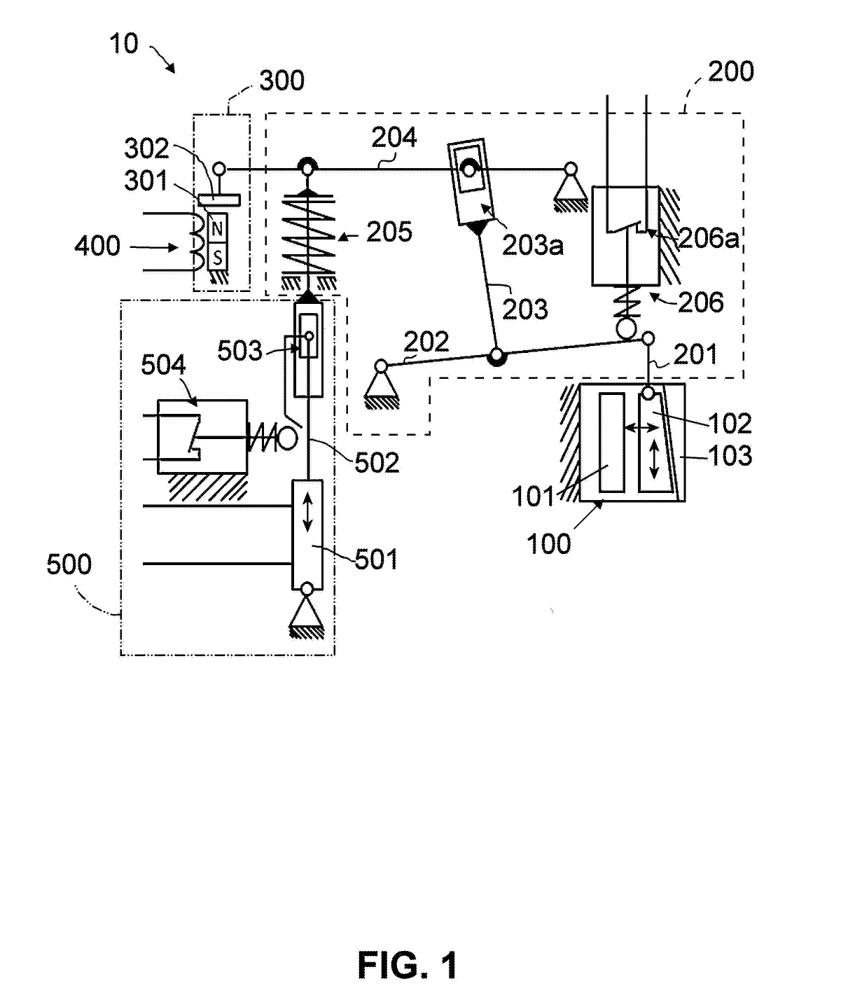

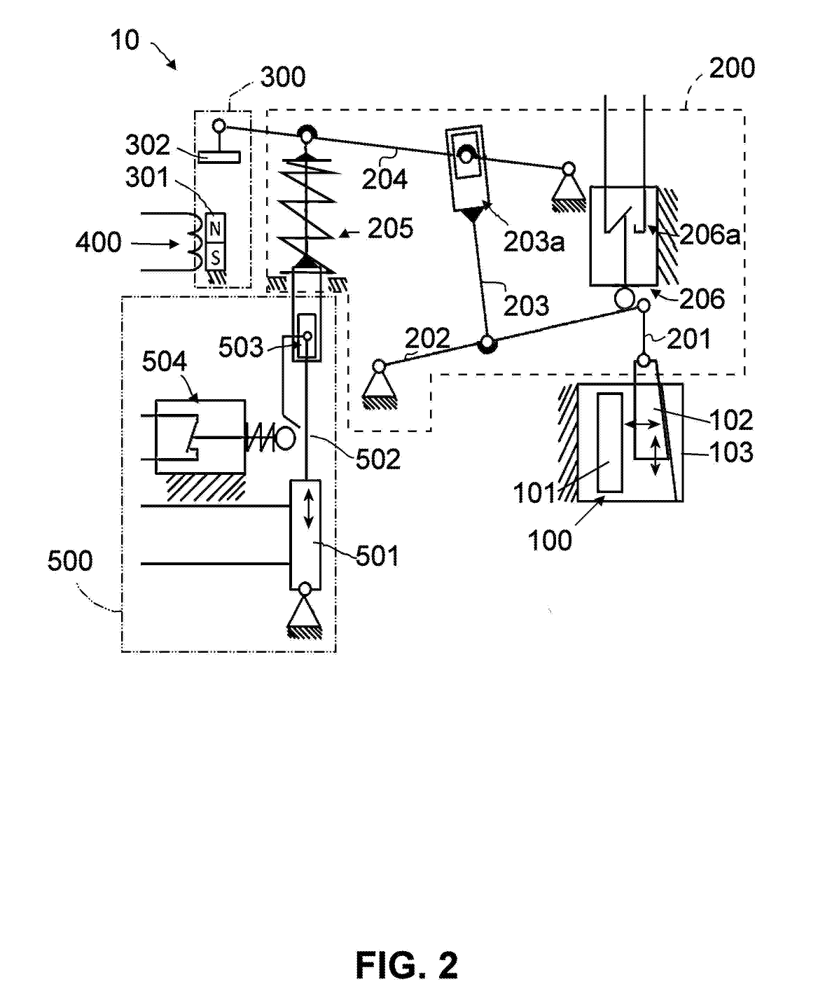

FIGS. 1 and 2 will be described together and each show, schematically, a preferred embodiment of a safety device 10 according to the invention for a lift installation. The safety device 10 is, for example, fixed to a lift car of a lift installation, the movement of which is to be braked.

The safety device 10 has an intercepting mechanism formed as a wedge brake 100 here, which, when actuated, is designed to brake a movement of a lift car (not shown) of the lift installation. For this purpose, the wedge brake 100 has a stationary brake shoe 101 and a wedge-like brake shoe 102 which can move vertically and horizontally in the figure (each indicated by double arrows), which is supported on an inclined plane 103. A guide rail (not shown) of the lift installation can, for example, run in an interspace between the brake shoes 101 and 102 and can be clamped in by closing the wedge brake 100.

The wedge brake 100, more precisely its movable brake shoe 102, is connected to a plunger 201 of an actuating mechanism 200. The actuating mechanism 200 is configured to assume a first and a second position, the actuating mechanism 200 leaving the wedge brake 100 non-actuated in the first position, shown in FIG. 1, and actuating the wedge brake 100 in the second position, shown in FIG. 2.

The actuating mechanism 200 has a coupler mechanism, which has a first lever acting as an actuating lever 202 here, and a second lever acting as a restoring lever 204 here, which are coupled via a coupling rod 203.

The actuating lever 202 is pivotably mounted at its left-hand end in the figure and, at its right-hand (i.e. movable) end in the figure is connected to the plunger 201. The actuating lever 202 is connected to the coupling rod 203 at a contact point located in between.

The restoring lever 204 is pivotably mounted at its right-hand end in the figure and, in the region of its movable end, is acted on with pressure or force by a pressure accumulator, formed here as a compression spring 205. At a contact point located between the bearing point and the pressure application point, the restoring lever 204 is likewise coupled to the coupling rod 203.

The coupling rod 203 has a freewheeling mechanism 203a, which permits the actuating mechanism 200 to be restored from the second position into the first position without simultaneously restoring the wedge brake 100 from the actuated position into the non-actuated position. In other words, the tensioning and restoring of the actuating mechanism 200, explained in more detail further below, when the safety device is triggered does not automatically also lead to release of the wedge brake; instead, provision is made for safety reasons that the wedge brake has to be released separately, for example manually.

In the embodiment shown, the actuating mechanism 200 additionally has an intercepting mechanism monitoring means 206, which monitors whether the wedge brake 100 is in the actuated or the non-actuated position. In the illustration shown, the intercepting mechanism monitoring means 206 has a switch 206a, which is closed when the wedge brake is open (see FIG. 1) and open when the wedge brake is closed (see FIG. 2).

The safety device 10 additionally has a holding device 300 which, in the example shown, is coupled to the restoring lever 204. However, without restricting the generality, it can also be coupled to the actuating lever 202.

The holding device 300 is designed to hold the actuating mechanism 200 in the first position, shown in FIG. 1, by using a permanent magnet 301, which attracts an associated armature 302 magnetically.

The safety device 10 also has an electromagnet 400, which is configured to release the holding device 300 when energized, in order to cause the compression spring 205 to force the actuating mechanism 200 out of the first position shown in FIG. 1 into the second position shown in FIG. 2. For this purpose, a magnetic field acting counter to the magnetic field from the permanent magnet 301 is generated by the electromagnet 400, so that the two magnetic fields substantially cancel out and the holding force is no longer sufficient to counteract the compressive force exerted by the compression spring 205.

Finally, the safety device 10 has a restoring mechanism 500, which is configured to restore the actuating mechanism 200 from the second position shown in FIG. 2 into the first position shown in FIG. 1. Alternatively or additionally, without restricting the generality, the restoring mechanism can also be configured to restore the wedge brake 100 from the actuated position to the non-actuated position.

For this purpose, here the restoring mechanism 500 has a spindle drive 501, in which a spindle 502 can be moved by an electric motor in the vertical direction in the figure (indicated by a double arrow). The spindle 501 is connected via a further freewheeling mechanism 503 to the restoring lever 204 of the actuating mechanism 200. In the figure, this connection coincides with the connection to the compression spring 205, but this is to be viewed purely by way of example.

The freewheeling mechanism 503 can, for example, be formed (just like the freewheeling mechanism 203) as a movable pin in a slot. The freewheeling mechanism 503 is used to permit a movement of the wedge brake 100 from the non-actuated position shown in FIG. 1 into the actuated position shown in FIG. 2 without any movement of the restoring mechanism or the electric motor of the latter. This ensures that the actuation of the wedge brake can be carried out substantially without any force and in particular does not have to be carried out counter to a holding force of the restoring mechanism or the electric motor of the latter.

The restoring mechanism 500 is also equipped with a restoring mechanism monitoring means 504, which monitors whether a movement of the wedge brake 100 from the non-actuated position into the actuated position is possible without any movement of the restoring mechanism 500 or the electric motor 501 of the latter. In the example shown, an electric switch of the monitoring means 504 is closed when the freewheeling mechanism 503 permits a movement of the restoring lever 204 and therefore, via the coupling rod 203, the actuating lever 202 and the plunger 201 of the brake shoe 102 as well, without simultaneously also moving the actuating mechanism 500 or the electric motor 501 of the latter. On the other hand, if the freewheeling mechanism 503 does not permit such a movement without also moving the actuating mechanism 500 or the electric motor 501 of the latter (since the spindle 502 has been retracted), the switch of the restoring mechanism monitoring means 504 is open.

The monitoring means 206 and 504 serve to increase safety to the effect that, when the switches are respectively closed, which permits the application of a quiescent current principle, the ability of the safety device to function or to be triggered is indicated.

A safety device according to the invention can be operated in a very energy-saving manner in normal operation, since the holding device is formed in such a way that it holds the actuating mechanism firmly without any current and has to be energized only briefly in order to trigger the holding function. In order nevertheless to satisfy safety requirements, an energy storage device is expediently provided, for example a capacitor or accumulator, with the aid of which the electromagnet can nevertheless be energized to trigger the safety device in the event of failure of an external power supply.

What is claimed is:

1. A safety device for a lift installation, the safety device comprising:
an intercepting mechanism, which, when actuated, is designed to brake a movement of a lift car of the lift installation,
an actuating mechanism, which is configured to assume a first and a second position, the actuating mechanism leaving the intercepting mechanism non-actuated in the first position and actuating the intercepting mechanism in the second position,
a pressure accumulator, which forces the actuating mechanism into the second position,
a holding device, which holds the actuating mechanism in the first position by using a permanent magnet, and
an electromagnet, which is configured to release the holding device when energized, in order to cause the pressure accumulator to force the actuating mechanism into the second position.

2. The safety device of claim 1, further comprising a restoring mechanism, which is configured to at least one of (i) restore the actuating mechanism from the second position into the first position and (ii) restore the intercepting mechanism from the actuated position into the non-actuated position.

3. The safety device of claim 2, wherein the restoring mechanism has at least one of an electric motor and a spindle drive.

4. The safety device of claim 2, wherein the restoring mechanism has a freewheeling mechanism which permits a movement of the intercepting mechanism from the non-actuated position into the actuated position without moving the restoring mechanism.

5. The safety device of claim 4, having a restoring mechanism monitoring means, which monitors whether a movement of the intercepting mechanism from the non-actuated position into the actuated position without moving the restoring mechanism is permitted.

6. The safety device of claim 1, further comprising: an intercepting mechanism monitoring means, which monitors whether the intercepting mechanism is in the actuated or the non-actuated position.

7. The safety device of claim 6 wherein the actuating mechanism is coupled directly to the intercepting mechanism, so that the intercepting mechanism is non-actuated when the actuating mechanism assumes the first position.

8. The safety device of claim 6, wherein the actuating mechanism is coupled to the intercepting mechanism by means of a freewheeling mechanism, which freewheeling mechanism permits the actuating mechanism to be restored from the second position into the first position without simultaneously restoring the intercepting mechanism from the actuated position into the non-actuated position.

9. The safety device of claim 1, wherein the intercepting mechanism has a self-reinforcing brake.

10. The safety device of claim 1, wherein the actuating mechanism has one of a lever mechanism and a coupler mechanism.

11. The safety device of claim 1, further comprising an energy storage device for energizing the electromagnet in the event of a failure of an external power supply.

12. The safety device of claim 1 wherein the pressure accumulator comprises one of a spring, a pneumatic pressure accumulator and a hydraulic pressure accumulator.

13. A method for triggering a safety device for a lift installation, wherein an electromagnet is energized in order to weaken a magnetic field from a permanent magnet to such an extent that an intercepting mechanism of the safety device, which is kept non-actuated by means of the permanent magnet and which is designed to brake a movement of a lift car of the lift installation when actuated, is actuated.

14. The method of claim 13, wherein the intercepting mechanism is actuated by a pressure accumulator that is under pressure.

15. The method of claim 14, wherein, in order to restore the intercepting mechanism, the pressure accumulator is pressurized and is then kept pressurized by the permanent magnet.

16. The method of claim 13, wherein the safety device is triggered and the safety device comprises:
an intercepting mechanism, which, when actuated, is designed to brake a movement of a lift car of the lift installation,
an actuating mechanism, which is configured to assume a first and a second position, the actuating mechanism leaving the intercepting mechanism non-actuated in the first position and actuating the intercepting mechanism in the second position,
a pressure accumulator, which forces the actuating mechanism into the second position,
a holding device, which holds the actuating mechanism in the first position by using a permanent magnet, and
an electromagnet, which is configured to release the holding device when energized, in order to cause the pressure accumulator to force the actuating mechanism into the second position
